(19) United States
(12) Patent Application Publication
(10) Pub. No.: US 2012/0295451 A1
(43) Pub. Date: Nov. 22, 2012

(54) Magnetic connecting device

(75) Inventors: Kim Hyun-Jun, Yuseong-gu (KR); Youn Dae-Young, Seoul (KR); Jeong Seung-Ju, Daedeok-gu (KR); Kim Jung Gyo, Yuseong-gu (KR); Kim Hyo-Nam, Yuseong-gu (KR)

(73) Assignee: SMART POWER SOLUTIONS, INC, Yuseong-gu (KR)

(21) Appl. No.: 13/349,850

(22) Filed: Jan. 13, 2012

(30) Foreign Application Priority Data
May 20, 2011 (KR) 10-2011-0047769

(51) Int. Cl. H01R 11/30

(52) U.S. Cl. 439/39

(57) ABSTRACT

The present invention relates to a magnetic connecting device, which is magnetically and electrically coupled to an external device via a communication-type magnetic connector and is configured to transfer operating power to the external device after checking the external device using communication when the external device is coupled to the connecting device, thus ensuring convenience and safety in use. The magnetic connecting device includes a plurality of power terminals magnetically coupled to a connector of an external device and configured to transfer power to the external device, and at least one communication terminal arranged adjacent to the plurality of power terminals and configured to come into contact with the connector of the external device and to transmit or receive data when the external device is coupled.

### TECHNICAL FIELD

The present invention relates to a magnetic connecting device having a communication-type power magnetic connector.

### BACKGROUND ART

Generally, mobile terminals such as mobile phones, smart phones, and Personal Digital Assistants (PDAs) have been universally used thanks to their excellent mobility and convenient portability. Accordingly, wired chargers for charging the batteries of mobile terminals have been manufactured to have different shapes in conformity with the shapes or standards of manufactured batteries. Due to a recent tendency to improve the functionality of mobile terminals and to pursue lightweight mobile terminals in conformity with consumers' requirements, mobile terminals having various shapes and chargers having various shapes that are suitable for the mobile terminals have been manufactured even in the same manufacturing company.

Recently, with the development of technology, new chargers have been popularized. In order to solve the problems of existing charging methods using such chargers, a wireless (contactless) charging method for charging batteries using magnetic induction without making electrical contact has been used.

A wireless power transmission device (inductive charger) that uses such a wireless charging method is convenient in that power is transmitted in a wireless manner in such a way that an external device is put on or held on a charging pad to charge a battery. However, from the standpoint of energy transfer, there are problems in that energy efficiency may be deteriorated according to the size of a non-contact space between the charging pad and the charger, the design thereof may be relatively complicated, and manufacturing costs may also increase.

### DISCLOSURE

### Technical Problem

Accordingly, the present invention has been made keeping in mind the above problems occurring in the prior art, and an object of the present invention is to provide a magnetic connecting device, which is magnetically and electrically coupled to an external device via a communication-type magnetic connector and is configured to transfer operating power to the external device after checking the external device using communication when the external device is coupled, thus ensuring convenience and safety in use.

Technical objects intended to be accomplished by the present invention are not limited to the above-described object, and other objects not described herein will be clearly understood by those skilled in the art from the following description.

### Technical Solution

In accordance with an aspect of the present invention to accomplish the above object, there is provided a magnetic connecting device, including a plurality of power terminals magnetically coupled to a connector of an external device and configured to transfer power to the external device; and at least one communication terminal arranged adjacent to the plurality of power terminals and configured to come into contact with the connector of the external device and to transmit or receive data when the external device is coupled.

Preferably, the power terminals may be made of magnetic materials having opposite polarities, and each of the power terminals may be made of any one of a permanent magnet, a ferromagnetic material, and a paramagnetic material.

Preferably, the power terminals may transfer Direct Current (DC) power or Alternating Current (AC) power to the external device.

Preferably, the communication terminal may be made of any one of a permanent magnet, a ferromagnetic material, and a paramagnetic material.

Preferably, the magnetic connecting device may further include a control unit for determining whether the external device has been connected via the communication terminal when the external device is coupled, and thereafter controlling whether to supply power to the external device via the power terminals. The control unit may compare identification information read from the external device with preset identification information when the external device is coupled, and then determine whether to supply power to the external device.

Preferably, the control unit may include a communication control unit for requesting identification information from the external device when the external device is coupled, and comparing the identification information read from the external device with preset identification information; and a power control unit for controlling a switch unit based on results of the comparison by the communication control unit, thus controlling whether to supply power to the external device. The switch unit may be disposed between a DC output terminal and the power terminals.

In accordance with another aspect of the present invention to accomplish the above object, there is provided a magnetic connecting device, including a plurality of power terminals coupled to a connector of an external device and configured to transfer power to the external device; and at least one communication terminal arranged adjacent to the plurality of power terminals and magnetically coupled to the connector of the external device, the communication terminal being configured to transmit or receive data when the external device is coupled.

Preferably, the power terminals may be made of magnetic materials having opposite polarities, and each of the power terminals may be made of any one of a permanent magnet, a ferromagnetic material, and a paramagnetic material.

Preferably, the power terminals may transfer Direct Current (DC) power or Alternating Current (AC) power to the external device.

Preferably, the communication terminal may be made of any one of a permanent magnet, a ferromagnetic material, and a paramagnetic material.

In accordance with a further aspect of the present invention to accomplish the above object, there is provided a magnetic connecting device, including a plurality of power terminals magnetically coupled to a connector of a power supply and configured to receive power from the power supply; and at least one communication terminal arranged adjacent to the plurality of power terminals and configured to come into contact with the connector of the power supply and to transmit or receive data when the power supply is coupled.

In accordance with yet another aspect of the present invention to accomplish the above object, there is provided a magnetic connecting device, including a plurality of power terminals coupled to a connector of a power supply and configured to receive power from the power supply; and at least one communication terminal arranged adjacent to the plurality of power terminals and magnetically coupled to the connector of the power supply, the communication terminal being configured to transmit or receive data when the power supply is coupled.

Preferably, the magnetic connecting device may further include a communication control unit for transferring pre-stored identification information to the power supply if identification information is requested via the communication terminal when the power supply is coupled.

In accordance with still another aspect of the present invention to accomplish the above object, there is provided a magnetic connecting device, including a plurality of power terminals magnetically coupled to a connector of an external device and configured to transfer power to the external device; at least one communication terminal arranged adjacent to the plurality of power terminals and coupled to the connector of the external device, the communication terminal being configured to transmit or receive data when the external device is coupled; and a control unit configured to check identification of the external device via the communication terminal when the external device is coupled, and thereafter to control whether to supply power to the external device via the power terminals.

Preferably, the power terminals may have coils wound therearound; and the control unit may supply currents to the coils if the identification information of the external device is different from preset identification information, thus compulsorily disconnecting the connector of the external device.

In accordance with still another aspect of the present invention to accomplish the above object, there is provided a magnetic connecting device, including a main connector including a plurality of power terminals that are magnetically coupled to a connector of an external device and configured to transfer power to the external device, and at least one communication terminal that is arranged between the power terminals and is configured to come into contact with the connector of the external device and to transmit or receive data when the external device is coupled; and a Universal Serial Bus (USB) connector extended from a first end of the main connector via a cable and configured to transmit externally input Direct Current (DC) power to the main connector.

### Advantageous Effects

As described above, the magnetic connector of the present invention is advantageous in that it has various applicable forms in such a way as to hold or put the magnetic connector on a predetermined location or to implement the independent coupling form of the magnetic connector itself. Accordingly, the magnetic connector can be more simply and inexpensively implemented than typical wireless power transmission devices, and has a very convenient structure from the standpoint of convenience of use. Further, the present invention is advantageous in that, from the standpoint of energy transfer, a power transfer form that does not cause deterioration of efficiency can be implemented.

### DESCRIPTION OF DRAWINGS

The above and other objects, features, and advantages of the present invention will be more clearly understood from the following detailed description taken in conjunction with the accompanying drawings, in which:

FIG. 1 is a conceptual diagram showing a magnetic connecting device according to the present invention;

FIGS. 2 to 7 are diagrams showing the external appearance of a main connector according to embodiments of the present invention;

FIG. 8 is a diagram showing a magnetic connecting device according to an embodiment of the present invention;

FIG. 9 is a diagram showing the detailed construction of a power supply to which a magnetic connector is applied according to an embodiment of the present invention;

FIG. 10 is a diagram showing the detailed construction of a power supply to which the magnetic connector is applied according to another embodiment of the present invention;

FIG. 11 is a diagram showing the detailed construction of a power supply to which the magnetic connector is applied according to a further embodiment of the present invention; and

FIG. 12 is a diagram showing the detailed construction of a power supply to which the magnetic connector is applied according to yet another embodiment of the present invention.

### BEST MODE

Hereinafter, preferred embodiments of the present invention will be described in detail with reference to the attached drawings. The same reference numerals are used throughout the different drawings to designate the same or similar components. If in the specification, detailed descriptions of well-known functions or configurations may unnecessarily make the gist of the present invention obscure, the detailed descriptions will be omitted.

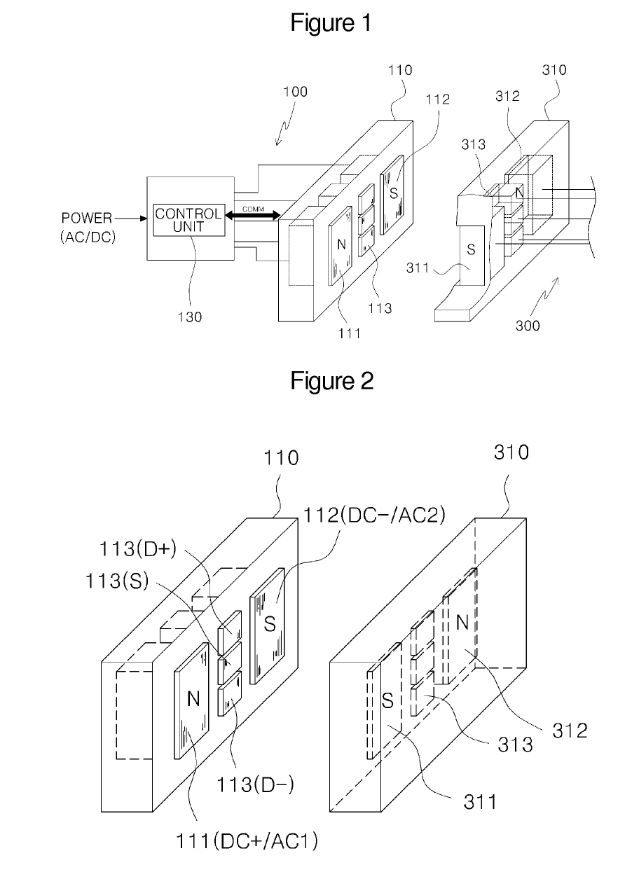

FIG. 1 is a conceptual diagram showing a magnetic connecting device according to the present invention, wherein the magnetic connecting device can be individually applied to a power supply 100 and an external device 300. The power supply 100 may be an adaptor for outputting input Direct Current (DC) power or converting externally input commercial Alternating Current (AC) power into DC power and supplying the DC power to the external device 300 connected thereto. The external device 300 may be any of small-capacity devices supplied with DC power, such as mobile terminals (a mobile phone, a PDA, a smart phone, or the like), notebook computers, or computer peripherals, or various types of devices supplied with high AC power or DC power, such as Uninterruptible Power Supply (UPS) devices, electric vehicles, electric bicycles, or electric scooters.

The power supply 100 and the external device 300 can be electrically connected to each other via their own magnetic connectors 110 and 310. Hereinafter, for convenience of description, the connector 110 of the power supply 100 is called a main connector, and the connector 310 of the external device 300 is called an external connector.

As shown in the drawing, the main connector 110 of the power supply 100 and the external connector 310 of the external device 300 may be formed to have the same structure or formed in a concavo-convex shape in which the connectors 110 and 310 structurally correspond to each other. When the main connector 110 and the external connector 310 are configured to have the same structure, first ends of the outer sides of power terminals 111 and 112 and a first end of the outer side of at least one communication terminal 113 may be located on the same horizontal plane. The main connector 110 of the power supply 100 and the external connector 310 of the external device 300 may be formed to physically match each other.

The power supply 100 includes the main connector 110 and a control unit 130, and the main connector 110 may include the first power terminal 111, the second power terminal 112, and the communication terminal 113.

The external device 300 includes the external connector 310, which may include a first power terminal 311, a second power terminal 312, and at least one communication terminal 313. The plurality of power terminals 311 and 312 are magnetically coupled to the power terminals 111 and 112 of the power supply 100, respectively, and receive power from the power supply 100. The communication terminal 313 may be implemented as one or more terminals that are arranged adjacent to the plurality of power terminals 311 and 312, are coupled to the communication terminal 113 of the power supply 100, and are used to transmit or receive data when the power supply 100 is coupled to the external device 300. In FIG. 1, although three communication terminals 113 are shown, the number of communication terminals 113 can be increased or decreased depending on the circumstances, and the arrangement locations and shapes of the communication terminals 113 may also be changed.

In the above description, when the power supply 100 and the external device 300 are electrically connected to each other, the control unit 130 of the power supply 100 and the external device 300 can be configured to perform preset communication. Before power from the power supply 100 is supplied to the external device 300, the external device 300 is driven in response to a communication signal transmitted from the power supply 100 and is then capable of communicating with the power supply 100.

The first power terminal 111 of the power supply 100 is magnetically coupled to the first power terminal 311 of the external device 300, and transfers supplied power DC+ or AC1 to the external device 300 when the external device 300 is coupled to the power supply 100. The second power terminal 112 is installed to be spaced apart from the first power terminal 111, and transfers supplied power DC− or AC2 to the second power terminal 312 of the external device 300 when the external device 300 is coupled to the power supply 100. In this case, each of the first power terminal 111 and the second power terminal 112 may be made of any one of a permanent magnet, a ferromagnetic material, and a paramagnetic material, and may be formed to have opposite polarities so as to obtain directionality with the external connector 310 of the external device 300. For example, when the first power terminal 111 has an N polarity, the second power terminal 112 has an S polarity.

The communication terminals 113 are arranged either adjacent to the power terminals 111 and 112 or between the power terminals 111 and 112, and are configured to come into contact with the communication terminals 313 of the external device 300 and to transmit or receive data when the external device 300 is coupled to the power supply 100. Such a communication terminal 113 may be made of any one of a permanent magnet, a ferromagnetic material, and a paramagnetic material. The communication terminals 113 may include at least one of data terminals D+ and D−, a signal terminal S, and a ground terminal GND.

The control unit 130 can determine whether the external device 300 has been connected, via the communication terminals 113, when the external device 300 is coupled to the power supply 100, and can thereafter control whether to supply power to the external device 300 via the power terminals 111 and 112. That is, the control unit 130 compares identification information read from the external device 300 with preset identification information when the external device 300 is coupled to the power supply 100, and then determines whether to supply power.

Meanwhile, the power supply 100 may further include auxiliary magnets installed around the first power terminal 111 and/or the second power terminal 112, and configured to intensify the magnetic force of the first power terminal 111 and/or the second power terminal 112.

When the auxiliary magnets are installed around the power terminals 111 and 112 in this way, each of the power terminals 111 and 112 may also be made of a non-magnetic material rather than a magnet.

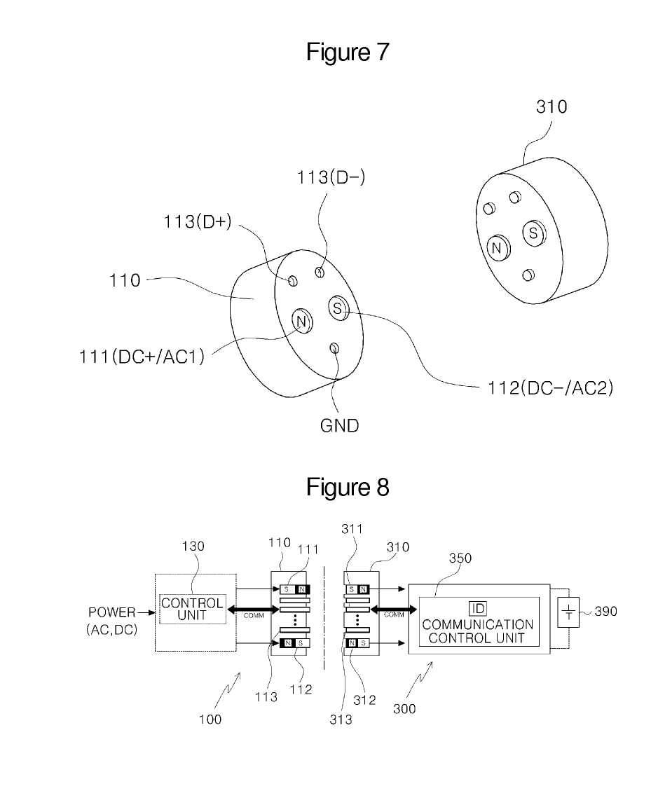

FIGS. 2 to 7 are diagrams showing various structures of the main connector and the external connector, wherein the main connector 110 can be formed to have a rectangular section, as shown in FIG. 2, or a circular section, as shown in FIG. 7. The communication terminals 113 are arranged between the plurality of power terminals 111 and 112 in FIGS. 2 to 6, and the communication terminals 113 are arranged around the power terminals 111 and 112 in FIG. 7.

Further, the main connector 110 and the external connector 310 may be formed in the shape of plates on which the power terminals 111 and 112, and 311 and 312, and the communication terminals 113 and 313 are individually formed, rather than the shape of typical connectors.

FIG. 2 illustrates the case where each of the first power terminal 111 and the second power terminal 112 of the main connector 110 is made of a permanent magnet, a ferromagnetic material, or a paramagnetic material, and where each communication terminal 113 is made of a nonmagnetic material or a paramagnetic material. As shown in FIG. 2, the terminals 111 to 113 of the main connector 110 can slightly protrude from the surface of the main connector 110, and first ends of the terminals 111 to 113 can be located on the same horizontal plane. Further, the individual terminals 311 to 313 of the external connector 310 can be slightly depressed from the surface of the external connector 310. In this case, the protrusion height of the main connector 110 may be equal to or greater than the depression depth of the external connector 310.

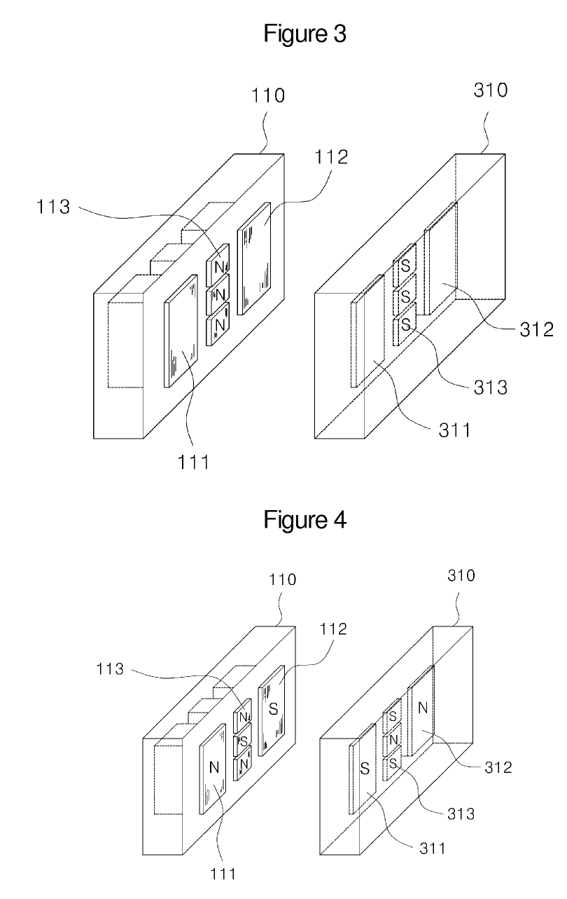

FIG. 3 illustrates the case where each of the first power terminal 111 and the second power terminal 112 of the main connector 110 is made of a nonmagnetic material or a paramagnetic material, and each communication terminal 113 is made of a permanent magnet, a ferromagnetic material, or a paramagnetic material.

FIG. 4 illustrates the case where all of the first power terminal 111, the second power terminal 112, and the communication terminals 113 of the main connector 110 are made of at least one of a permanent magnet, a ferromagnetic material, and a paramagnetic material. The magnet described in the present invention denotes one of a permanent magnet, a ferromagnetic material, and a paramagnetic material. In this way, when all terminals 111 to 113 are made of magnets, it is more profitable to divide the polarities of the magnets into N polarity and S polarity in half and simultaneously form N-polarity magnets and S-polarity magnets without alternately forming N-polarity magnets and S-polarity magnets, from the standpoint of magnetic force and directionality.

In this case, the individual terminals 311 to 313 of the external connector 310 magnetically coupled to the main connector 110 may be formed to have magnetic polarities that are opposite those of the individual terminals 111 to 113 of the main connector 110, as shown in FIGS. 2 to 4.

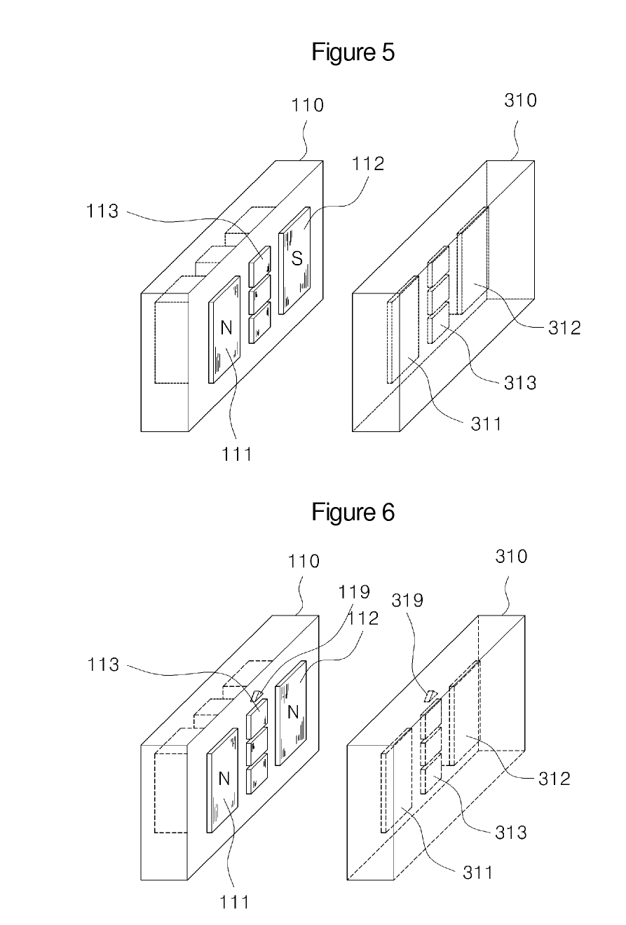

Further, as shown in FIG. 5, the external connector 310 may be made of a ferromagnetic material or a paramagnetic material, rather than a permanent magnet. That is, each of the connectors 311 to 313 of the external connector 310 may be made of a ferromagnetic material or a paramagnetic material even when the terminals 111 to 113 of the main connector 110 are permanent magnets. It is important that at least one of the terminals 111 to 113 of the main connector 110 and the terminals 311 to 313 of the external connector 310 needs only to be a permanent magnet.

FIG. 6 illustrates the case where a projection 119 is formed at a predetermined position of the main connector 110 to maintain mounting directionality between the main connector 110 and the external connector 310. A depression 319 is formed at a location of the external connector 310, corresponding to that of the projection 119. The projection 119 and the depression 319 can be formed to have various shapes or formed in a plural number depending on the circumstances. When the projection 119 and the depression 319 are respectively formed at the main connector 110 and the external connector 310, all terminals 111 to 113 of the main connector 110 may be formed to have the same polarity (N polarity or S polarity). In this case, the external connector 310 may be made of a ferromagnetic material or a paramagnetic material, as well as a permanent magnet.

FIG. 7 illustrates the case where the main connector is formed to have a circular section. Even in this case, the first power terminal 111 and the second power terminal 112 are formed in opposite polarities.

In the above description, a method for communication between the power supply 100 and the external device 300 may be at least one of Serial Communication Interface (SCI) communication, Controller Area Network (CAN) communication, and Power Line Communication (PLC). The SCI communication may include Electrically Erasable Programmable Read-Only Memory (EEPROM) communication, RS232, RS422, RS485, and I²C communication methods, etc. The structures of the connectors 110 and 310, the number of terminals 111 to 113, the arrangement shape of the terminals, etc. may be determined according to the communication method between the power supply 100 and the external device 300.

That is, it is apparent that the main connector 110 may have a sectional shape corresponding to at least one of a plate, a rectangle, a polygon, a circle, and an ellipse depending on the circumstances, and that the size of the main connector 110 may change in various manners. The external connector 310 of the external device 300 will necessarily have a shape corresponding to that of the main connector 110 of the power supply 100.

Meanwhile, in the present invention, the main connector 110 and the external connector 310 are shown to be implemented in a surface contact manner. However, in order to improve the contact performance and design tolerance of each terminal, predetermined elastic bodies (not shown) can be installed inside the first power terminal 111, the second power terminal 112, and the communication terminals 113. Such an elastic body may be a spring, rubber, or the like.

It is apparent that elastic bodies can be installed in the terminals 311, 312, and 313 of the external connector 310, and elastic bodies can also be installed in both the connectors 110 and 310. When an elastic body is installed in the main connector 110, the individual terminals 111, 112, and 113 may be formed to protrude outwardly, and the individual terminals 311, 312, and 313 of the external connector 310 may be formed to be slightly depressed inwardly.

FIG. 8 is a diagram showing a magnetic connecting device according to an embodiment of the present invention, wherein the magnetic connecting device can be individually connected to the power supply 100 and to the external device 300.

The power supply 100 includes a main connector 110 and a control unit 130. The main connector 110 may include a first power terminal 111, a second power terminal 112, and at least one communication terminal 113.

The external device 300 includes an external connector 310 and a communication control unit 350. The external connector 310 may include a first power terminal 311, a second power terminal 312, and at least one communication terminal 313. The plurality of power terminals 311 and 312 are coupled to the main connector 110 of the power supply 100 and configured to receive power from the power supply 100. The communication terminal 313 may be implemented as one or more communication terminals that are arranged adjacent to the plurality of power terminals 311 and 312, are magnetically coupled to the connector 110 of the power supply 100, and are configured to transmit or receive data when the power supply 100 is coupled to the external device 300. The communication control unit 350 is configured such that if identification information is requested via the communication terminals 313 when the power supply 100 is coupled to the external device 300, pre-stored identification information is transferred to the power supply 100.

That is, when the power supply 100 is electrically connected to the external device 300, the control unit 130 of the power supply 100 and the communication control unit 350 of the external device 300 are configured to perform preset communication. Before power from the power supply 100 is supplied to the external device 300, the communication control unit 350 of the external device 300 is driven by an internal battery 390 and is then capable of communicating with the power supply 100. In this case, when no battery is included in the external device 300, the external device 300 is driven in response to a communication signal received from the power supply 100 and is then capable of communicating with the power supply 100.

Hereinafter, the present invention based on the power supply 100 and the main connector 110 thereof will be described.

The first power terminal 111 of the power supply 100 is magnetically coupled to the external connector 310 of the external device 300, and is configured to transfer supplied power DC+ or AC1 to the external device 300 when the external device 300 is coupled to the power supply 100. The second power terminal 112 is installed to be spaced apart from the first power terminal 111 by a predetermined interval, and is configured to transfer supplied power DC− or AC2 to the external device 300 when the external device 300 is coupled to the power supply 100.

The communication terminals 113 are arranged either adjacent to the plurality of power terminals 111 and 112 or between the power terminals 111 and 112, and are configured to come into contact with the external connector 310 of the external device 300 and to transmit or receive data when the external device 300 is coupled to the power supply 100. Each of the communication terminals 113 may be made of any one of a permanent magnet, a ferromagnetic material, and a paramagnetic material. The communication terminals 113 may include at least one of data terminals D+ and D−, a signal terminal S, and a ground terminal GND.

The control unit 130 determines whether the external device 300 has been connected via the communication terminals 113 when the external device 300 is coupled to the power supply 100, and thereafter controls whether to supply power to the external device 300 via the power terminals 111 and 112. That is, the control unit 130 compares the identification information read from the external device 300 with preset identification information when the external device 300 is coupled to the power supply 100, and then determines whether to supply power. The identification information may be product information, a unique number, etc.

Therefore, the control unit 130 allows the power to be output via the first power terminal 111 and the second power terminal 112 only when the external device 300 is connected to the power supply 100. The principal reason for forming configuration in this way is that safety can be guaranteed against accidents such as electric shocks when impurities come into contact with the main connector 110.

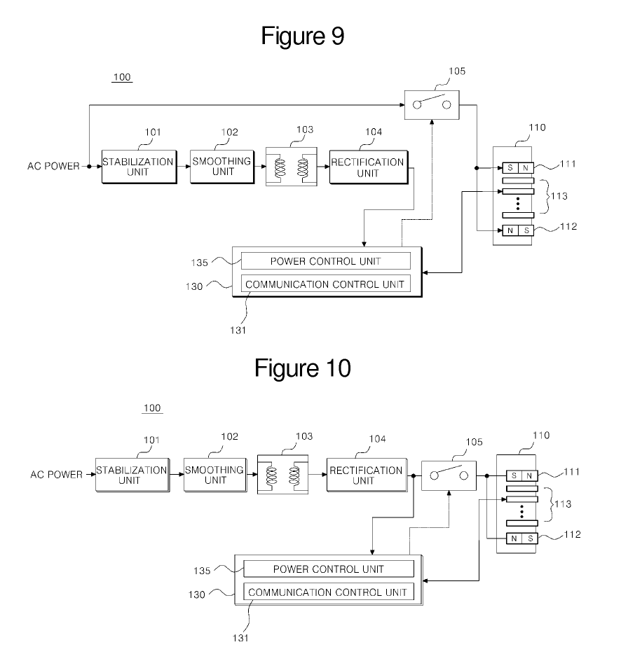

FIG. 9 is a diagram showing the detailed structure of a power supply to which a magnetic connector is applied according to an embodiment of the present invention. In the drawing, the power supply 100 includes a stabilization unit 101, a smoothing unit 102, a transformation unit 103, a rectification unit 104, a switch unit 105, a main connector 110, and a control unit 130. The power supply 100 may be connected to the external device 300, as shown in FIG. 8.

The stabilization unit 101 is configured to boost an externally input commercial AC voltage, for example, a voltage of AC 110V or AC 220V, about 1.414 times, or to stabilize the input AC voltage.

The smoothing unit 102 smoothes the voltage output from the stabilization unit 101 and then outputs a voltage close to a DC voltage. That is, the smoothing unit 102 minimizes ripple components contained in the voltage output from the stabilization unit 101, thus reducing ripple noise.

The transformation unit 103 drops the voltage output from the smoothing unit 102 to a required voltage level, and outputs a resulting voltage. The transformation unit 103 includes a primary coil and a secondary coil. The number of windings of the primary coil and the number of windings of the secondary coil are suitably adjusted, thus enabling noise at an output terminal to be reduced.

The rectification unit 104 rectifies the voltage output from the secondary coil of the transformation unit 103, and outputs a DC voltage to the main connector 110. Since the voltage generated on the secondary side of the transformation unit 103 is close to a square wave, the rectification unit 104 rectifies the voltage, thus enabling the voltage output via the main connector 110 to be converted into a DC voltage. The rectification unit 104 minimizes ripple noise using an inductor coil, thus causing the output voltage to be closer to the DC voltage.

The switch unit 105 is installed between the rectification unit 104, which is a DC output stage, and the power terminals of the main connector 110, and is switched in response to a predetermined control signal to output the power input from the rectification unit 104 to the power terminals of the main connector 110. Of course, the switch unit 105 may be switched in response to the control signal, but may be configured to be switched on/off according to the selection of a user.

The main connector 110 is magnetically coupled to the external connector 310 of the external device 300, and is configured to transmit/receive data to/from the external connector 310 of the external device 300 and to transfer power to the external connector 310. The main connector 110 is configured to include the first power terminal 111, the second power terminal 112, and at least one communication terminal 113. That is, the main connector 110 includes the first power terminal 111 which is magnetically coupled to the external connector 310 of the external device 300 and is configured to transfer supplied power to the external device 300 when the external device 300 is coupled to the power supply 100, the second power terminal 112 which is installed to be spaced apart from the first power terminal 111 by a predetermined interval and is configured to transfer supplied power to the external device 300 when the external device 300 is coupled to the power supply 100, and the communication terminal 113 which is arranged between the power terminals 111 and 112 and is configured to come into contact with the external connector 310 of the external device 300 and to transmit or receive data when the external device 300 is coupled to the power supply 100. Here, the first power terminal 111 and the second power terminal 112 can be formed as magnets having opposite polarities so as to realize directionality with the external connector 310 of the external device 300. The communication terminal 113 can also be formed as a magnet depending on the circumstances.

The control unit 130 checks the identification information of the external device 300 via the communication terminal 113 when the external device 300 is coupled to the power supply 100, and thereafter controls whether to supply power to the external device 300 via the power terminals 111 and 112. In detail, as shown in the drawing, the control unit 130 may include a communication control unit 131 and a power control unit 135. That is, the communication control unit 131 requests identification information from the external device 300 when the external device 300 is coupled to the main connector 110, and compares the identification information, read from the communication control unit 350 of the external device 300 in compliance with a request command, with preset identification information. The power control unit 135 controls the switch unit 105 on the basis of the results of the comparison by the communication control unit 131, thus determining whether to supply power to the external device 300. Therefore, the control unit 130 allows the power to be output via the first power terminal 111 and the second power terminal 112 only when the set external device 300 is connected to the power supply 100.

In this way, the present invention is configured such that when the power supply 100 and the external device 300 are magnetically connected to each other, the control unit 130 of the power supply 100 and the communication control unit 350 of the external device 300 perform preset communication before power is supplied to the external device 300. Before power from the power supply 100 is supplied to the external device 300, the communication control unit 350 of the external device 300 may be driven by an internal battery 390 or a signal input via the communication terminals 113, thereby communicating with the power supply 100.

FIG. 10 is a diagram showing the detailed structure of a power supply to which the magnetic connector is applied according to another embodiment of the present invention. The power supply 100 may include a stabilization unit 101, a smoothing unit 102, a transformation unit 103, a rectification unit 104, a switch unit 105, a main connector 110, and a control unit 130. The power supply 100 may be connected to the external device 300, as shown in FIG. 8.

Unlike the structure of FIG. 9, the structure of FIG. 10 is greatly characterized in that AC power rather than DC power is applied to the main connector 110, and a brief description will be given based on this structure.

That is, the rectification unit 104 rectifies a voltage output from the secondary coil of the transformation unit 103 and then outputs the rectified voltage to the control unit 130.

The switch unit 105 is disposed between an AC input terminal and the main connector 110, and is switched in response to a predetermined control signal to output the externally input AC power to the main connector 110.

The main connector 110 is magnetically coupled to the external connector 310 of the external device 300, and is configured to transmit or receive data to or from the external connector 310 of the external device 300 and to transfer operating power to the external connector 310. The main connector 110 includes a first power terminal 111, a second power terminal 112, and at least one communication terminal 113.

The control unit 130 checks the identification information of the external device 300 via the communication terminal 113 when the external device 300 is coupled to the power supply 100, and thereafter controls whether to supply power to the external device 300 via the power terminals 111 and 112. In detail, as shown in the drawing, the control unit 130 may include a communication control unit 131 and a power control unit 135. That is, the communication control unit 131 requests identification information from the external device 300 when the external device 300 is coupled to the main connector 110, and compares the identification information read from the communication control unit 350 of the external device 300 in compliance with a request command with preset identification information. The power control unit 135 controls the switch unit 105 on the basis of the results of the comparison by the communication control unit 131, thus determining whether to supply power to the external device 300. Therefore, the control unit 130 allows the input AC power to be output via the first power terminal 111 and the second power terminal 112 only when the set external device 300 is connected to the power supply 100.

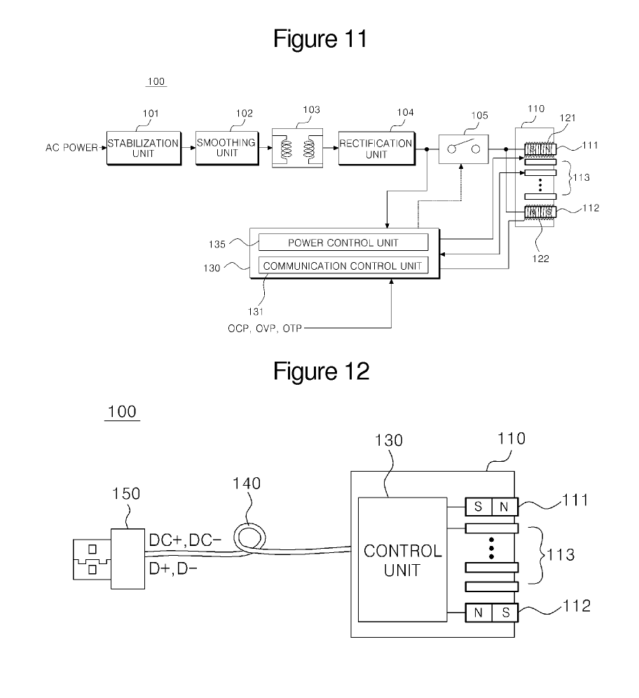

FIG. 11 is a diagram showing the detailed structure of a power supply to which the magnetic connector is applied according to a further embodiment of the present invention. The power supply 100 may include a stabilization unit 101, a smoothing unit 102, a transformation unit 103, a rectification unit 104, a switch unit 105, a main connector 110, coils 121 and 122, and a control unit 130. The power supply 100 may be connected to the external device 300, as shown in FIG. 8.

FIG. 11 illustrates the structure in which coils are respectively wound around the power terminals 111 and 112, unlike the structure of FIG. 9, thus enabling the coils to have polarities identical or opposite to those of the power terminals depending on the direction of currents that is externally applied.

That is, the main connector 110 is magnetically coupled to the external connector 310 of the external device 300, and is configured to transmit or receive data to or from the external connector 310 of the external device 300 and to transfer operating power to the external connector 310. The main connector 110 includes a first power terminal 111, a second power terminal 112, and at least one communication terminal 113.

The control unit 130 checks the identification information of the external device 300 via the communication terminal 113 when the external device 300 is coupled to the power supply 100, and thereafter controls whether to supply power to the external device 300 via the power terminals 111 and 112. In detail, as shown in the drawing, the control unit 130 may include a communication control unit 131 and a power control unit 135. That is, the communication control unit 131 requests identification information from the external device 300 when the external device 300 is coupled to the main connector 110, and compares the identification information read from the communication control unit 350 of the external device 300 in compliance with a request command with preset identification information. If the identification information of the external device 300 is identical to the preset (pre-stored) identification information as the result of the comparison by the communication control unit 131, the power control unit 135 turns on the switch unit 105, thus enabling operating power to be supplied to the external device 300.

If the identification information of the external device 300 is different from the pre-stored identification information, the power control unit 135 applies currents to the coils 121 and 122 respectively wound around the power terminals 111 and 112 to magnetize the power terminals 111 and 112 of the main connector 110 in the same polarities as those of the power terminals 311 and 312 of the external device 300 while turning off the switching unit 105, thus compulsorily disconnecting the external connector 310 of the external device 300. That is, the coils 121 and 122 are wound around the power terminals 111 and 112 and generate magnetic fields depending on the applied currents, and thus operate as electromagnets for weakening the magnetic force of the power terminals 111 and 112. The currents are applied to the coils 121 and 122 so that magnetic fields are generated in the direction in which the magnetic force of the power terminals 111 and 112 is weakened.

Meanwhile, even in the case where a signal for over-current protection (OCP), over-voltage protection (OVP) or an over-temperature protection (OTP) is externally input, the control unit 130 applies currents to the coils 121 and 122 respectively wound around the power terminals 111 and 112, so that the power terminals 111 and 112 of the main connector 110 are magnetized in the same polarities as those of the power terminals 311 and 312 of the external device 300, thus compulsorily disconnecting the external connector 310 of the external device 300.

Therefore, the control unit 130 enables input DC power or AC power to be output via the first power terminal 111 and the second power terminal 112 only when the set external device 300 is connected to the power supply 100. In the main connectors 110 of FIGS. 9 and 10, the power terminals 111 and 112 and the communication terminal 113 may be formed as at least one of magnets and electromagnets.

FIG. 12 is a conceptual diagram showing a power supply to which the magnetic connector is applied according to yet another embodiment of the present invention. The power supply 100 includes a main connector 110, a control unit 130, and a Universal Serial Bus (USB) connector 150. The power supply 100 may be connected to the external device 300, as shown in FIG. 8.

The main connector 110 includes a plurality of power terminals 111 and 112 which are magnetically coupled to the external connector 310 of the external device 300 and are configured to transfer power to the external device 300, and at least one communication terminal 113 which is arranged between the power terminals 111 and 112 and is configured to come into contact with the external connector 310 of the external device 300 and to transmit or receive data when the external device 300 is coupled to the main connector 110.

The control unit 130 checks the identification information of the external device 300 via the communication terminal 113 when the external device 300 is coupled to the main connector 110, and then controls whether to supply power to the external device 300 via the power terminals 111 and 112. In this case, the control unit 130 is shown to be included in and integrated into the main connector 110, but may be installed outside the main connector 110 if necessary.

The USB connector 150 is extended from one end of the main connector 110 via a cable 140, and is configured to transfer DC power DC+ and DC− and data D+ and D−, which are input from an external system (for example, from a computer), to the main connector 110.

Thus, in the power supply 100 of FIG. 12, when the main connector 110 is coupled to the external connector 310 of the external device 300, DC power input from the computer, an adaptor, or the like is transferred to the external device 300 via the USB connector 150 and the main connector 110. As the power supply 100 is manufactured as a USB connector-type portable device, convenience of use can be improved.

Various applicable forms can be implemented in such a way as to hold the main connector configured in this way at a specific location, to place the external device on the main connector, or to simply couple the main connector to the external connector of the external device. These forms enable the connecting device to be more simply and inexpensively implemented than typical wireless power transmission devices, and to be very simply and conveniently used. Further, from the standpoint of energy transfer, the connecting device has a power transfer form that does not cause the deterioration of efficiency.

The present invention has been described based on preferred embodiments, and those skilled in the art will be able to implement other embodiments differing from those of the detailed description of the present invention without departing from the essential technical scope of the present invention. Here, the essential technical scope of the present invention will be disclosed in the claims, and differences falling within the scope of the claims and equivalents thereof should be interpreted as being included in the present invention.

### MODE FOR INVENTION

### Industrial Applicability

As described above, the magnetic connector of the present invention is advantageous in that it has various applicable forms in such a way as to hold or put the magnetic connector on a predetermined location or to implement the independent coupling form of the magnetic connector itself. Accordingly, the magnetic connector can be more simply and inexpensively implemented than typical wireless power transmission devices, and has a very convenient structure from the standpoint of convenience of use. Further, the present invention is advantageous in that, from the standpoint of energy transfer, a power transfer form that does not cause deterioration of efficiency can be implemented.

1. A magnetic connecting device, comprising:
a plurality of power terminals magnetically coupled to a connector of an external device and configured to transfer power to the external device; and
at least one communication terminal arranged adjacent to the plurality of power terminals and configured to come into contact with the connector of the external device and to transmit or receive data when the external device is coupled.

2. The magnetic connecting device according to claim 1, wherein the power terminals are made of magnetic materials having opposite polarities.

3. The magnetic connecting device according to claim 1, wherein each of the power terminals is made of any one of a permanent magnet, a ferromagnetic material, and a paramagnetic material.

4. The magnetic connecting device according to claim 1, wherein the power terminals are implemented as electromagnets around which coils are respectively wound.

5. The magnetic connecting device according to claim 1, wherein the power terminals transfer Direct Current (DC) power or Alternating Current (AC) power to the external device.

6. The magnetic connecting device according to claim 1, wherein the communication terminal is made of any one of a permanent magnet, a ferromagnetic material, and a paramagnetic material.

7. The magnetic connecting device according to claim 1, wherein first ends of outer sides of the power terminals and a first end of an outer side of the communication terminal are located on an identical horizontal plane.

8. The magnetic connecting device according to claim 1, further comprising a control unit for determining whether the external device has been connected via the communication terminal when the external device is coupled, and thereafter controlling whether to supply power to the external device via the power terminals.

9. The magnetic connecting device according to claim 8, wherein the control unit compares identification information read from the external device with preset identification information when the external device is coupled, and then determines whether to supply power to the external device.

10. The magnetic connecting device according to claim 8, wherein the control unit comprises:
a communication control unit for requesting identification information from the external device when the external device is coupled, and comparing the identification information read from the external device with preset identification information; and
a power control unit for controlling a switch unit based on results of the comparison by the communication control unit, thus controlling whether to supply power to the external device.

11. The magnetic connecting device according to claim 10, wherein the switch unit is disposed between a DC output terminal and the power terminals.

12. The magnetic connecting device according to claim 10, wherein the switch unit is disposed between an AC output terminal and the power terminals.

13. The magnetic connecting device according to claim 1, wherein the communication terminal and the external device communicate with each other using at least one of Serial Communication Interface (SCI) communication, Controller Area Network (CAN) communication, and Power Line Communication (PLC) methods.

14. A magnetic connecting device, comprising:
a plurality of power terminals coupled to a connector of an external device and configured to transfer power to the external device; and
at least one communication terminal arranged adjacent to the plurality of power terminals and magnetically coupled to the connector of the external device, the communication terminal being configured to transmit or receive data when the external device is coupled.

15. The magnetic connecting device according to claim 14, wherein the communication terminal is made of any one of a permanent magnet, a ferromagnetic material, and a paramagnetic material.

16. The magnetic connecting device according to claim 14, wherein the communication terminal is arranged between the power terminals.

17. The magnetic connecting device according to claim 14, wherein the power terminals are made of magnetic materials having opposite polarities.

18. The magnetic connecting device according to claim 14, further comprising a control unit for determining whether the external device has been connected via the communication terminal when the external device is coupled, and thereafter controlling whether to supply power to the external device via the power terminals.

19. The magnetic connecting device according to claim 18, wherein the control unit compares identification information read from the external device with preset identification information when the external device is coupled, and then determines whether to supply power to the external device.

20. A magnetic connecting device, comprising:
a plurality of power terminals magnetically coupled to a connector of a power supply and configured to receive power from the power supply; and
at least one communication terminal arranged adjacent to the plurality of power terminals and configured to come into contact with the connector of the power supply and to transmit or receive data when the power supply is coupled.

21. The magnetic connecting device according to claim 20, wherein the power terminals are made of magnetic materials having opposite polarities.

22. The magnetic connecting device according to claim 20, wherein each of the power terminals is made of any one of a permanent magnet, a ferromagnetic material, and a paramagnetic material.

23. The magnetic connecting device according to claim 20, wherein the power terminals receive Direct Current (DC) power or Alternating Current (AC) power from the power supply.

24. The magnetic connecting device according to claim 20, wherein the communication terminal is made of any one of a permanent magnet, a ferromagnetic material, and a paramagnetic material.

25. The magnetic connecting device according to claim 20, wherein first ends of outer sides of the power terminals and a first end of an outer side of the communication terminal are located on an identical horizontal plane.

26. The magnetic connecting device according to claim 20, further comprising a communication control unit for transferring pre-stored identification information to the power supply if identification information is requested via the communication terminal when the power supply is coupled.

27. A magnetic connecting device, comprising:
a plurality of power terminals coupled to a connector of a power supply and configured to receive power from the power supply; and
at least one communication terminal arranged adjacent to the plurality of power terminals and magnetically coupled to the connector of the power supply, the communication terminal being configured to transmit or receive data when the power supply is coupled.

28. The magnetic connecting device according to claim 27, wherein the communication terminal is made of any one of a permanent magnet, a ferromagnetic material, and a paramagnetic material.

29. The magnetic connecting device according to claim 27, wherein the communication terminal is arranged between the power terminals.

30. The magnetic connecting device according to claim 27, wherein the power terminals are made of magnetic materials having opposite polarities.

31. The magnetic connecting device according to claim 27, further comprising a communication control unit for transferring pre-stored identification information to the power supply if identification information is requested via the communication terminal when the power supply is coupled.

32. A magnetic connecting device, comprising:
a plurality of power terminals magnetically coupled to a connector of an external device and configured to transfer power to the external device;
at least one communication terminal arranged adjacent to the plurality of power terminals and coupled to the connector of the external device, the communication terminal being configured to transmit or receive data when the external device is coupled; and
a control unit configured to check identification of the external device via the communication terminal when the external device is coupled, and thereafter to control whether to supply power to the external device via the power terminals.

33. The magnetic connecting device according to claim 32, wherein each of the power terminals is made of any one of a permanent magnet, a ferromagnetic material, and a paramagnetic material.

34. The magnetic connecting device according to claim 32, wherein:
the power terminals have coils wound therearound; and
the control unit supplies currents to the coils if the identification information of the external device is different from preset identification information, thus compulsorily disconnecting the connector of the external device.

35. The magnetic connecting device according to claim 32, wherein the communication terminal is made of any one of a permanent magnet, a ferromagnetic material, and a paramagnetic material.

36. A magnetic connecting device, comprising:
a main connector including a plurality of power terminals that are magnetically coupled to a connector of an external device and configured to transfer power to the external device, and at least one communication terminal that is arranged between the power terminals and is configured to come into contact with the connector of the external device and to transmit or receive data when the external device is coupled; and
a Universal Serial Bus (USB) connector extended from a first end of the main connector via a cable and configured to transmit externally input Direct Current (DC) power to the main connector.

37. The magnetic connecting device according to claim 36, further comprising a control unit for determining whether the external device has been connected via the communication terminal when the external device is coupled, and thereafter controlling whether to supply power to the external device via the power terminals.

38. The magnetic connecting device according to claim 36, wherein the control unit is integrated into the main connector.

39. The magnetic connecting device according to claim 36, wherein each of the power terminals is made of any one of a permanent magnet, a ferromagnetic material, and a paramagnetic material.

40. The magnetic connecting device according to claim 36, wherein the communication terminal is made of any one of a permanent magnet, a ferromagnetic material, and a paramagnetic magnet.
